(19) United States
(12) Patent Application Publication
(10) Pub. No.: US 2005/0218667 A1
(43) Pub. Date: Oct. 6, 2005

(54) Operating device for unlocking a movable lid of a motor vehicle

(75) Inventors: Bernd Nabert, Schopfloch (DE); Erwin Lutz, Schwieberdingen (DE); Frank Diehm, Kirchheim (DE)

Correspondence Address: CROWELL & MORING LLP;INTELLECTUAL PROPERTY GROUP, P.O. BOX 14300, WASHINGTON, DC, 20044-4300, US

(73) Assignee: Dr.Ing.h.c.F. Porsche Aktiengesellschaft, Stuttgart (DE)

(21) Appl. No.: 11/092,655

(22) Filed: Mar. 30, 2005

(30) Foreign Application Priority Data
Mar. 30, 2004 (DE) 10 2004 015 348.5

(51) Int. Cl. E05B 3/00

(52) U.S. Cl. 292/336.3

(57) ABSTRACT

An operating device is provided for unlocking at least one movable lid of a motor vehicle. The operating device can be arranged on a side of a side member of the motor vehicle facing a vehicle interior and includes a side member covering and at least one triggering element held on a bearing housing, arranged on the side member covering. For a simple producibility of operating device, it is provided that the side member covering has a slide-in shaft for the bearing housing between whose shaft wall and a bearing housing wall a guiding device is provided which extends in the slide-in direction. The guiding device has a guide rail and a rail receiving device. In a cross-sectional view, the guiding device is constructed as a reach-behind contour. A fastening device for the bearing housing is arranged on the side member covering.

### BACKGROUND AND SUMMARY OF THE INVENTION

This application claims the priority of German Application No.: 10 2004 015 348.5 filed on Mar. 30, 2004, the disclosure of which is expressly incorporated by reference herein.

The invention is based on an operating device for unlocking at least one movable lid of a motor vehicle. Certain preferred embodiments of the present invention relate to an operating device for unlocking at least one movable lid of a motor vehicle, which operating device can be arranged on the side of a side member of the motor vehicle facing a vehicle interior, said operating device having a side member covering at least one triggering element held on a bearing housing, which bearing housing is arranged on the side of member covering.

An operating device of the above-mentioned type is known from European Patent Document EP 0 778 386 B1 (corresponding U.S. Pat. No. 5,927,794). The operating device can be arranged on a side of a side member of a motor vehicle facing a vehicle interior. It comprises a side member covering on which a bearing housing is arranged at which a triggering element for the unlocking of the lid is held. The triggering element is constructed as a swivellably disposed lever which is connected with a lid lock by means of a pulling device. In the case of the known operating device, the bearing housing is constructed in one piece with the side member covering.

It is an object of the invention to provide an operating device of the above-mentioned type which is easy to manufacture.

This object is achieved according to certain preferred embodiments of the present invention by providing an operating device for unlocking at least one moveable lid of a motor vehicle, which operating device can be arranged on the side of a side member of the motor vehicle facing a vehicle interior, said operating device having a side member covering and at least one triggering element held on a bearing housing, which bearing housing is arranged on the side member covering, wherein the side member covering has a slide-in shaft (opening) for the bearing housing between whose shaft wall and a bearing housing wall a guiding device is provided which extends in a slide-in direction, which guiding device has a guide rail and a rail receiving device, wherein, in a cross-section view, the guiding device is constructed as a reach-behind contour, and wherein a fastening device for the bearing housing is provided on the side member covering. Further developments of the preferred embodiments of the invention are described herein and in the claims.

Advantages achieved by means of the invention are, on the one hand, represented by the two-part construction of the operating device with the side member covering and the separate bearing housing. This results in simple production shapes for the production of such parts which are usually made of a plastic material. On the other hand, because of the guiding device designed with a reach-behind contour, a firm connection of the bearing housing and the side member covering is achieved, so that no gap or only a small gap exists between the bearing housing and the slide-in shaft on the side member covering, whereby a visually high-quality appearance is achieved. Furthermore, it is advantageous that—without requiring changes at the side member covering—different bearing housings can be used for different equipment of the motor vehicle. Thus, different bearing housings with one or more triggering elements for corresponding parts of the motor vehicle can be inserted into the side member covering.

It is achieved according to certain preferred embodiments of the invention, that a non-uniform gap formation is avoided in the surrounding space between the slide-in shaft and the bearing housing, by providing an arrangement wherein the guiding device has several guide rails and rail receiving devices which are correspondingly arranged on the shaft wall and on the bearing housing wall in a distributed manner.

According to certain preferred embodiments of the invention, the fasting device is constructed as a detent connection, to thereby achieve a simple and fast mounting and simultaneously a secure fastening of the bearing housing on the side member covering, since the detent connection can become effective when the bearing housing is completely slid in.

According to certain preferred embodiments of the invention, the side member covering and the bearing housing are symmetrically constructed with respect to a transverse center axis which extends parallel to a transverse vehicle axis, wherein the guiding device is arranged symmetrically with respect to this transverse center axis, wherein two triggering elements are arranged on the bearing housing, and wherein the bearing housing and the slide-in shaft are symmetrically constructed with respect to a longitudinal center axis which extends parallel to the longitudinal vehicle axis. With this arrangement, a mounting of the operating device can be carried out on the right or left side member. The assignment of a triggering element for a respective lid is maintained because only the side member covering is rotated corresponding to its mounting site. However, the bearing housing with the triggering elements remains aligned in the same manner with respect to the vehicle front or the vehicle rear. This arrangement is particularly advantageous when the triggering elements are provided with different symbols which show, for example, the forward and rearward lid, and the bearing housing is to be slid in a correspondingly correct position with respect to the lids into the side member covering. Thus, the bearing housing and the side member covering can easily be used for left-hand-steered or right-hand-steered vehicles.

According to certain preferred embodiments of the invention, a bearing housing can be fastened to the side member covering which, in a variant, in addition or as an alternative to the at least one triggering element, has an operating element, preferably an electric switch, for another part of the motor vehicle.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of a motor vehicle with a forward and rearward lid as well as an operating device for unlocking the lids, constructed according to preferred embodiments of the present invention;

FIG. 2 is a detailed view of the operating device having a side member covering and a bearing housing with triggering elements;

FIG. 3 is a view of an enlarged cutout of the side member covering;

FIG. 4 is a partial sectional view of a representation of the operating device according to Line IV-IV in FIG. 2; and

FIG. 5 is a partial sectional view along Line V-V in FIG. 4.

### DETAILED DESCRIPTION OF THE DRAWINGS

A motor vehicle 1, particularly a passenger car, illustrated in FIG. 1 has a vehicle body 3 carried by wheels 2 and comprising a body shell 4 which has at least one opening into which a movable, particularly swivellable lid 5 is inserted. In the illustrated embodiment, two openings and therefore two lids 5 and 6 are provided, one of which being arranged adjacent to the vehicle front 7 and one being arranged adjacent to the vehicle rear 8. In FIG. 1, both lids 5 and 6 are illustrated in their closed position ST and, in this closed position ST, are each held by a lid lock 9 and 10 respectively. In order to be able to open the lid or lids 5, 6, the respective lock 9 or 10 can be selectively unlocked by means of an operating device 11 arranged away from the lid locks 9 and 10 on the vehicle 1. The operating device 11 is connected with the locks 9 and 10 by way of one line 12 respectively. Preferably, the locks 9 and 10 are electrically controllable for the unlocking. For this purpose, one triggering element 13 or 14 respectively, particularly switches, assigned to the locks 9 and 10 is held on the operating device 11, and the line is constructed as an electric line 12.

The operating device 11 is arranged on a side 16 of the side member 17 or 18 assigned to a vehicle interior 15, which side members 17, 18 are part of the vehicle body 3. In the illustrated embodiment, the vehicle 1 is constructed as a so-called left-hand-steered vehicle having a steering wheel 19 on the left vehicle side 20, and the lids 5 and 6 can be unlocked from the driver side (vehicle side 20). In another embodiment, the vehicle 1 can be implemented as a right-hand-steered vehicle, in the case of which the steering wheel 19 is then arranged on the right vehicle side 21 in the interior 15. In particular, it is provided that the operating device 11 is fastened laterally next to the respective front vehicle seat 22 or 23 on the side member 17 or 18.

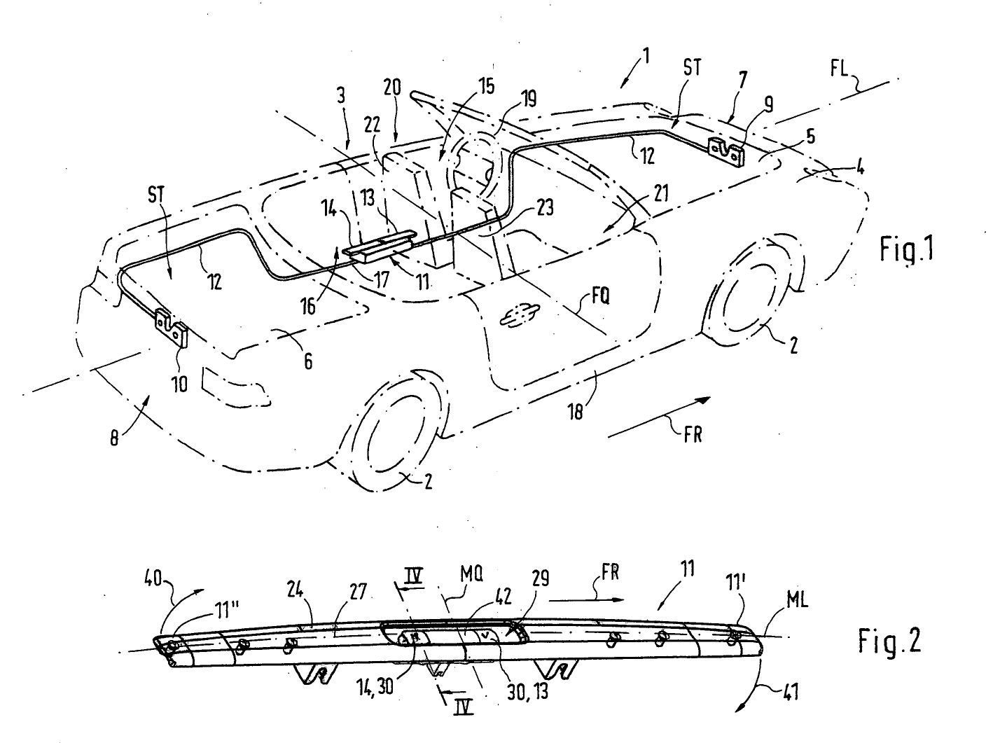

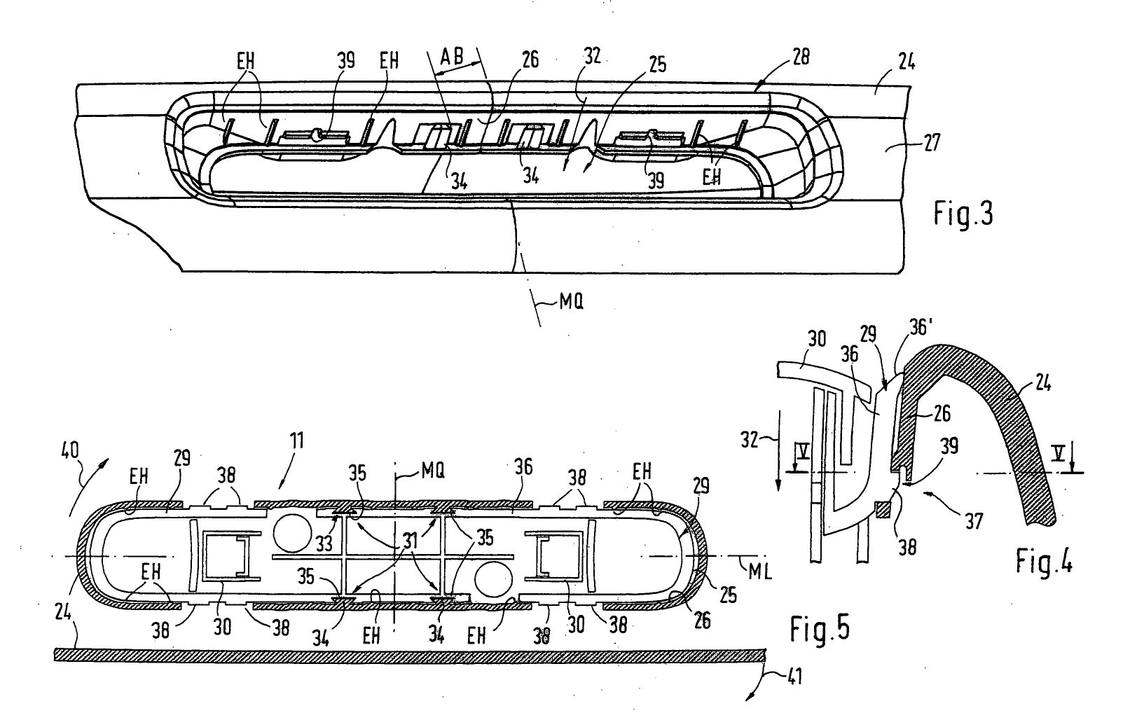

By means of FIGS. 2 to 5, the operating device 11 is described in detail. The operating device 11 has a longitudinal center axis ML which extends approximately parallel and at a lateral distance with respect to a longitudinal axis FL of the vehicle indicated in FIG. 1. It also has a transverse center axis MQ which extends parallel and at a distance with respect to a transverse vehicle axis FQ illustrated in FIG. 1. The operating device 11 comprises a side member covering 24 which can be connected with the side member 17 or 18 and which is constructed approximately in a plate shape, particularly adapted to the side member contour of the side member 17 or 18 on the side 16. With respect to the longitudinal center axis ML and/or the transverse center axis MQ, a slide-in shaft (opening) 25 is made in the center into the side member covering 24, which slide-in shaft 25 has an upright, preferably surrounding shaft wall 26. The slide-in shaft 25 on the top side 27 of the side member covering 24 leads into a slide-in opening 28. By way of the slide-in opening 28, a bearing housing 29 is inserted into the slide-in shaft 25, which bearing housing 29 carries the triggering elements 13 and 14, which are preferably constructed as keys 30 of electric switches not illustrated here.

Between the shaft wall 26 and the bearing housing 29, a guiding device 31 is provided which is aligned in the slide-in direction 32 of the bearing housing 29 and has a reach-behind contour 33, particularly in the shape of a dovetail joint. Other reach-behind shapes 33 would also be conceivable, such as L-shaped, T-shaped or circular or semicircular contours. At least with respect to the transverse center axis MQ and/or the longitudinal center axis ML, the guiding device 31 is arranged symmetrically on the slide-in shaft 25 or bearing housing 29 also constructed symmetrically to these axes MQ and/or ML. Thus, several guide rails 34 and rail receiving devices 35 are provided as guiding devices 31 which, in their cross-section, have the reach-behind contour 33 and are, correspondingly in pairs, arranged at a distance AB with respect to the transverse center axis MQ distributed between the shaft wall 26 and the bearing housing 29. In the illustrated embodiment, the guide rails 34 are arranged on the shaft wall 26 projecting over the latter, and the rail receiving devices 35 are correspondingly constructed in a bearing housing wall 36 of the bearing housing 29. A reverse arrangement would be conceivable.

A fastening device 37 is also provided for making it possible to connect the bearing housing 29 after the sliding into the shaft 25 with the side member covering 24 and to hold it therein. This fastening device 37 is preferably constructed as one or more detent connections acting between the shaft wall 36 and the bearing housing 29 or its housing wall 36. FIG. 4 illustrates the detent connection which, in the embodiment shown, comprises at least one detent nose 38 and an assigned detent eye 39, which detent nose 38 having, for example, an elastic construction, in any case, engages in the detent eye 39. Several detent connections may be constructed on the shaft wall 26 and correspondingly on the housing wall 36 in a distributed manner. In addition, one or more elevations EH, for example, in the form of webs, are arranged in a distributed manner, for example, on the shaft wall 26 or the housing wall 26, on which elevations EH the bearing housing wall 36 is supported, whereby a play between the shaft wall 26 and the bearing housing wall 36 is compensated. FIG. 4 illustrates that the bearing housing wall 36 is constructed in a free-standing and optionally elastic manner and is supported on the shaft wall 26 by means of its free end 36′. As a result of the reach-behind contour 33 of the guiding device 31, the bearing housing wall 36 is fixedly held on the shaft wall 26.

In FIG. 2, symbols V and H respectively are mounted on the keys 30 or triggering elements 13 and 14, whereby each triggering element 13 and 14 can in each case be assigned to one of the lids 5 and 6. FIG. 2 shows the installation position of the operating device 11 for the left-hand-controlled vehicle 1 illustrated in FIG. 1 on the left side member 17. In this case, the operating device 11 is aligned in the direction of the arrow FR (FIGS. 1 and 2) which points from the vehicle rear 8 in the direction of the vehicle front 7 and thus corresponds to the driving direction during forward driving. One end 11′ of the side member covering 24 therefore points in the direction of the vehicle front 7, while another end 11″ of the side member covering 24 points to the rear 8. The triggering element 13 marked with the symbol V is therefore situated adjacent to the end 11′, and the triggering element 14 provided with the symbol H is assigned to the end 11″. In order to be able to use the operating device 11 for a right-hand-controlled vehicle on the right side member 18, the side member covering 24 is rotated by 180° without the bearing housing 29, which is indicated by arrows 40 and 41 in FIGS. 2 and 5. This means that the end 11′ now points in the direction of the rear 8, and the end 11″ points to the front 7. However, the orientation of the bearing housing 20 with the triggering elements 13 and 14 for the forward and rearward lid 5 and 6 illustrated in FIG. 2 is maintained, so that the key 30 with the symbol V continues to be assigned to the forward lid 5 or now to the end 11″ of the side member covering 24 and the key 30 with the symbol H continues to be assigned to the rearward lid 6 or not to the end 11′. The side member covering 24 is symmetrical at least with respect to the transverse center axis MQ, and the bearing housing 29 is preferably implemented symmetrically with respect to the transverse center axis MQ and with respect to the longitudinal center axis ML. Furthermore, at least the slide-in shaft 25 of the side member covering has a symmetrical construction also with respect to the longitudinal center axis ML.

Between the keys 30 or the triggering elements 13, 14, an optionally removable panel 42 is arranged on the bearing housing 29 in the embodiment. Instead of the panel 42, at least another triggering element, which is not shown here, for another part to be unlocked or to be operated, such as a filler neck compartment lid or the like, of the motor vehicle 1 could be arranged. In addition or as an alternative, instead of the triggering element(s) or the panel 42, an operating element for a part which is to be moved, such as a convertible top or the like, of the motor vehicle 1, can be arranged on the bearing housing 29.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Operating device for unlocking at least one movable lid of a motor vehicle, which operating device can be arranged on the side of a side member of the motor vehicle facing a vehicle interior, said operating device having a side member covering and at least one triggering element held on a bearing housing, which bearing housing is arranged on the side member covering,
wherein the side member covering has a slide-in shaft for the bearing housing between whose shaft wall and a bearing housing wall a guiding device is provided which extends in a slide-in direction, which guiding device has a guide rail and a rail receiving device,
wherein, in a cross-sectional view, the guiding device is constructed as a reach-behind contour, and
wherein a fastening device for the bearing housing is provided on the side member covering.

2. Operating device according to claim 1, wherein the reach-behind contour is constructed as a dovetail contour.

3. Operating device according to claim 1, wherein the guiding device has several guide rails and rail receiving devices which are correspondingly arranged on the shaft wall and on the bearing housing wall in a distributed manner.

4. Operating device according to claim 1, wherein the fastening device is constructed as a detent connection.

5. Operating device according to claim 4, wherein the detent connection is arranged between the shaft wall and the bearing housing wall.

6. Operating device according to claim 1, wherein the side member covering and the bearing housing are symmetrically constructed with respect to a transverse center axis which extends parallel to a transverse vehicle axis,
wherein the guiding device is arranged symmetrically with respect to this transverse center axis,
wherein two triggering elements are arranged on the bearing housing, and
wherein the bearing housing and the slide-in shaft are symmetrically constructed with respect to a longitudinal center axis which extends parallel to the longitudinal vehicle axis.

7. Operating device according to claim 1, wherein two triggering elements are provided which each have a different symbol which is assigned to a respective lid.

8. Operating device according to claim 7, wherein a panel is arranged on the bearing housing between the triggering elements.

9. Operating device according to claim 7, wherein another triggering element and/or an operating element for a part of the motor vehicle is provided between the triggering elements.

10. Operating device according to claim 1, wherein the bearing housing is formed as a plastic molded part.

11. Operating device according to claim 1, wherein the side member covering is formed as a plastic molded part.

12. Operating device according to claim 10, wherein the side member covering is formed as a plastic molded part.

13. Operating device according to claim 3, wherein the side member covering and the bearing housing are symmetrically constructed with respect to a transverse center axis which extends parallel to a transverse vehicle axis,
wherein the guiding device is arranged symmetrically with respect to this transverse center axis,
wherein two triggering elements are arranged on the bearing housing, and wherein the bearing housing and the slide-in shaft are symmetrically constructed with respect to a longitudinal center axis which extends parallel to the longitudinal vehicle axis.

14. Operating device according to claim 5, wherein the side member covering and the bearing housing are symmetrically constructed with respect to a transverse center axis which extends parallel to a transverse vehicle axis,
wherein the guiding device is arranged symmetrically with respect to this transverse center axis,
wherein two triggering elements are arranged on the bearing housing, and wherein the bearing housing and the slide-in shaft are symmetrically constructed with respect to a longitudinal center axis which extends parallel to the longitudinal vehicle axis.

15. Operating device according to claim 14, wherein the detent connection includes an interengaging elastic section of one of the bearing housing and side member covering.

16. Operating device according to claim 6, wherein the bearing housing is formed as a plastic molded part.

17. Operating device according to claim 6, wherein the side member covering is formed as a plastic molded part.

18. Operating device according to claim 17, wherein the bearing housing is formed as a plastic molded part.

19. Operating device according to claim 18, wherein two triggering elements are provided which each have a different symbol which is assigned to a respective lid.

20. Operating device according to claim 19, wherein a panel is arranged on the bearing housing between the triggering elements.

21. Operating device according to claim 19, wherein another triggering element and/or an operating element for a part of the motor vehicle is provided between the triggering elements.
